(19) United States
(12) Patent Application Publication
(10) Pub. No.: US 2018/0178438 A1
(43) Pub. Date: Jun. 28, 2018

(54) METHOD FOR PARAMETERIZATION OF A STATION FOR HEATING A CONTAINER PRODUCTION FACILITY

(71) Applicant: SIDEL PARTICIPATIONS, Octeville-sur-Mer (FR)

(72) Inventors: Arnaud DELAUNAY, OCTEVILLE-SUR-MER (FR); Guy FEUILLOLEY, OCTEVILLE-SUR-MER (FR)

(21) Appl. No.: 15/848,525

(22) Filed: Dec. 20, 2017

(30) Foreign Application Priority Data
Dec. 23, 2016 (FR) 1663276

(51) Int. Cl. B29C 49/64; B29C 49/78

(52) U.S. Cl. CPC B29C 49/6418; B29C 49/06; B29C 49/786

(57) ABSTRACT

A method for parameterization of a station of a production facility for heating a series of containers based on heated preforms including: determining a preform parameter; determining a parameter that is representative of the heating station; determining a heating adjustment parameter making it possible for the heating station to heat the preforms at the reference temperature based on the machine parameter; and adjusting the heating station according to the preform and heat adjustment parameters.

The invention relates to the field of the manufacturing of containers (in particular bottles, flasks) by forming based on preforms made of plastic, such as, for example, polyethylene terephthalate (PET).

The manufacturing of such containers is carried out in a facility comprising a heating station and a forming machine, equipped with a series of molds bearing the impression of the container model that is to be formed and corresponding injection devices.

The manufacturing comprises two main phases: namely a phase for heating preforms, during which a series of preforms is heated at a reference temperature at which the preforms are in a malleable state in which they can be formed, and a forming phase, during which the heated preforms are each transferred into a mold of the forming machine and a pressurized fluid is injected into each preform by the corresponding injection device to impart to the preform the final shape of the container. The pressurized fluid is, for example, a gas, such as air. The forming generally includes a stretching phase that is carried out by means of a movable rod that is arranged to apply a stretching force on the bottom of a preform in a mold so as to stretch the preform along its axis, which contributes to keeping the preform centered in relation to the mold.

A production facility generally comprises a console based on which numerous parameters can be adjusted manually: in the heating station, for example: heating temperature, travel speed of the preforms, power of the ventilation ensuring the evacuation of a portion of the heat; in the forming machine: injection pressure, stretching speed, thermal regulation temperature of the mold, if necessary.

During the heating phase, it is crucial that each preform be heated at a reference temperature that is uniform from one preform to the next so as to ensure a satisfactory follow-on forming of the preform into a container. The reference temperature is encompassed between the glass transition temperature and the crystallization temperature of the material of the preform. It is difficult, however, to regulate the heating station so that it heats the preforms in a precise and repeated way at the desired temperature. Actually, although it is known in theory how to supply the heating station so that it delivers a desired temperature, a difference between the regulated temperature and the actual temperature of the preform is often noted at the outlet of the heating station. This deviation is due to several factors such as the loss of heat in the furnace, the radiation absorption coefficient of the material of the preform, the specific heat of the preform, the length of exposure of the preform to the heat emitted by the furnace that depends on the operating pace of the heating station, etc. The temperature of the preform at the outlet of the heating station therefore depends both on the heating station and the preform itself, and this temperature will not be the same for the same adjustment of the heating station from one preform model to the next. Thus, the initial parameterization of the heating station is complicated and should be carried out again with each change of the preform model. To adjust the heating station, the procedure is generally carried out by trial and error by modifying the adjustment parameters of the heating station to reduce little by little the deviation between the reference temperature and the actual temperature of the preform until a preform that is heated at the reference temperature is obtained at the outlet of the heating station.

This operation is labor-intensive and takes a long time to implement and requires the presence of an operator having proper knowledge of the production facility and models of preforms that can be introduced into the facility. It would be desirable to simplify and automate this operation of parameterization of the heating station.

The document WO-2016/012704 describes a method for adjustment of a container production facility in which a production recipe associated with a container model that is to be produced from a preform model is selected in a database and is used to control the operation of the facility to produce a container in conformance with the container model from a preform in conformance with the preform model. The production recipe comprises in particular control parameters of the furnace, such as a mean power to deliver to heat sources.

The method includes a phase for verification of the characteristics of the container that is obtained and correction of the recipe in the event that one of these characteristics is out of compliance. However, this verification phase is carried out after a container has been produced, i.e., after the forming phase, which makes it necessary to run the entire facility to adjust the heating station. In addition, the step for correcting the recipe is done also by trial and error, which is labor-intensive, as indicated above.

One of the objects of the invention is to overcome the drawbacks above by proposing a method for parameterization of a heating station that can be automated simply.

For this purpose and according to a first aspect, the invention relates to a method for parameterization of a station for heating a series of preforms made of plastic from a given preform model for a facility for producing a series of containers from a given container model from said series of preforms heated at a reference temperature in said heating station, with the adjustment method comprising the following steps:

Determining at least one preform parameter relative to the given preform model,

Determining at least one machine parameter, representative of the heating capacity of the heating station,

Determining at least one heating adjustment parameter, making it possible for the heating station to heat the series of preforms in conformance with said given preform model at said reference temperature based on the machine parameter,

Adjusting said heating station according to said preform and heat adjustment parameters,

in which the step for determining the adjustment parameter of the heating station comprises at least one iteration of the following steps:

Determining the amount of theoretical energy that is to be provided to a preform in conformance with the preform model for heating said preform at the reference temperature,

Heating at least one preform in conformance with the preform model in said parameterized heating station to provide said amount of theoretical energy to said preform,

Measuring at least one parameter that is linked to the temperature of the preform that is heated in said heating station in such a way as to determine the deviation between the actual temperature of the preform at the end of said heating step and the reference temperature,

Adjusting the amount of energy provided by the heating station based on said deviation so that a preform that is heated by said adjusted amount of energy is heated at said reference temperature at the outlet of the heating station, with the heating adjustment parameter comprising said adjusted amount of energy.

The parameterization method according to the invention therefore makes it possible to adjust the heating station independently from the rest of the production facility without making it necessary to run the entire facility to carry out this adjustment. In addition, the adjustment of the amount of energy that is to be provided to the preform can be calculated based on the amount of theoretical energy and the value of the parameter that is linked to the temperature of the heated preform that is measured at the outlet of the heating station. Thus, this adjustment can be made in an automated way, which simplifies the parameterization of the heating station.

According to a characteristic of the parameterization method according to the invention, the parameterization of the heating station for applying the amount of theoretical energy that is to be provided to the preform takes into account an initial yield coefficient of the heating station between the energy that is emitted by the heating station and the energy that is actually received by the preform, with an actual yield coefficient being calculated based on the deviation between the actual temperature of the preform at the end of the heating step and the reference temperature, with said actual yield coefficient being taken into account to adjust the heating station in such a way as to provide the adjusted amount of energy to the preform.

Taking into account the yield coefficient of the heating station for the adjustment of the amount of energy makes it possible to carry out the initial adjustment of the heating station with a parameter that already takes into account the loss of energy between the energy that is emitted by the heating station and the energy that is actually received by the preform, which makes it possible to obtain a preform that is heated at a temperature that is close to the heating temperature at the end of the heating step and thus to minimize the necessary adjustment. In addition, with the actual yield coefficient of the heating station being obtained by calculation, it can be determined in an automated way.

According to other characteristics of the parameterization method according to the invention:

The heating station comprises at least one heating element that can emit a heating power toward the preform, with the adjustment of the amount of energy provided by the heating station comprising a modification of said heating power based on the length of exposure of said preform to said heating power emitted by the heating element,

The heating station comprises a chamber, a conveyor conveying the series of preforms along a path running through the chamber, the preforms having a body extending in a transverse direction in relation to the path, and a series of heating elements that are distributed in a matrix along the path and in the transverse direction, with said heating elements being able to emit a maximum heating output corresponding to the addition of the heating powers of each heating element, the adjustment of the heating station for applying the amount of theoretical energy comprising the calculation of a fraction of said maximum heating output corresponding to said amount of theoretical energy based on the length of exposure of a preform to the heating elements along the path and the distribution of said fraction over at least a part of said heating element and the adjustment of the heating station for applying the adjusted amount of energy comprising the calculation of an adjusted fraction of said maximum heating output corresponding to said adjusted amount of energy based on the length of exposure of a preform to the heating elements along the path and the distribution of said adjusted fraction over at least a part of said heating elements, with said distribution of the adjusted fraction forming an adjustment parameter of the heating station.

The adjustment of the amount of energy that is to be provided to the preform is made by the distribution of the heating power to the heating elements rather than by a simple modification of the total heating power, which makes possible a finer adjustment of the amount of energy, by adapting the temperature profile that is applied to the preform along its path in the heating station to obtain the reference temperature at the outlet of the heating station, and a homogeneous distribution of the heating along the preform, i.e., along its axis.

According to other characteristics of the parameterization method according to the invention:

The distribution of a fraction of the maximum heating output comprises the selection of heating elements to be turned on along the path and the supplying of said heating elements with a heating power that is close to their maximum output,

The increase in the amount of energy during the adjustment step of the heating station for applying the adjusted amount of energy comprises the selection and the supplying of additional heating elements and in which the reduction of the amount of energy during the adjustment step of the heating station for applying the adjusted amount of energy comprises the selection and the turning-off of heating elements from among the selected heating elements and/or the modification of the heating power of at least a part of said heating elements.

The adjustment of the amount of energy is done, for example, by supplying or turning off heating elements rather than by modifying the heating power of each heating element for the major variations of the amount of energy. This makes it possible to run each heating element close to its maximum heating output, which improves its efficiency, and to simplify the adjustment of the heating station since it is enough to turn on or turn off heating elements. For a finer adjustment, the heating power of one or more of these heating elements is optionally adjusted so as to achieve the exact amount of energy desired.

According to other characteristics of the parameterization method according to the invention:

The input parameter relative to the preform model that is introduced into the facility comprises the mass and the height of at least one part of the preform that is measured along the axis (A) of said preform, with said preform part being the part of the preform that is intended to be heated in the heating station.

The parameter that is linked to the temperature of the preform that is heated in the heating station (14) comprises the temperature that is measured in a given zone of the preform (4).

Selecting the temperature that is measured in a given zone of the preform as a parameter that is linked to the temperature of the preform that is heated in the heating station, for example the temperature that is measured at a point of the preform, makes it possible to simplify the measurement of the parameter that can be carried out by simple measuring means.

According to a second aspect, the invention relates to a method for initial adjustment of a facility for producing a series of containers from a given container model based on a series of preforms made of plastic from a given preform model, with said facility comprising a station for heating said series of preforms, in which said series of preforms is heated at a reference temperature, and a machine for forming said series of preforms that are heated at said reference temperature, in which the preforms of said series of preforms are successively formed into containers, with the adjustment method comprising the following steps:

Determining at least one adjustment parameter of the heating making it possible for the heating station to heat the series of preforms in conformance with said given preform model at said reference temperature by means of the method for parameterization of an above-mentioned heating station,

Determining at least one container parameter relative to the container model that is to be produced based on said given preform model,

Determining at least one adjustment parameter of the forming making it possible for the forming machine to produce a series of containers in conformance with said container model based on said series of preforms that are heated at said reference temperature,

Adjusting said production facility according to said preform, container, heating adjustment, and forming adjustment parameters.

As indicated above, the adjustment method according to the invention makes it possible to adjust the heating station independently of the forming machine. Thus, the adjustment of the heating station or the forming machine does not make it necessary to run the entire facility.

According to another characteristic of the adjustment method, the step for determining at least one adjustment parameter of the forming machine comprises the calculation of said parameter based on pre-recorded formulas and said input parameters, with said formulas linking at least one input parameter relative to the preform model to the input parameter relative to the container model to be produced based on the adjustment parameter of the forming.

The determination of the adjustment parameter of the forming station is done by calculation, which makes it possible to avoid steps of trial and error to obtain the parameter that makes it possible to obtain the desired container.

According to another aspect, the invention also relates to a method for initial adjustment of a facility for producing a series of containers from a given container model based on a series of preforms made of plastic from a given preform model, with said facility comprising at least one forming machine, comprising at least one forming station in which a preform of the series of preforms is formed into a container, with the initial adjustment method comprising the following steps:

Determining at least one preform parameter relative to the preform model that is introduced into the facility and at least one container parameter relative to the container model that is to be produced based on said preform model,

Determining at least one adjustment parameter of the forming machine that makes it possible to produce a container in conformance with said container model based on a preform in conformance with said preform model,

Adjusting said forming machine according to said preform, container and adjustment parameters,

in which the step for determining at least one adjustment parameter of the forming machine is done by calculation based on pre-recorded formulas, with said formulas using the preform parameter and the container parameter.

Advantageously, the pre-recorded formulas are obtained by regression of a database that contains information correlating a number of adjustment parameters of the forming machine and a number of preform models and a number of container models.

Advantageously, multiple preform and container parameters are determined, with each pre-recorded formula using at least one of said preform parameters and at least one of said container parameters to calculate at least one adjustment parameter of the forming machine.

Advantageously, the preform parameters comprise at least the following parameters for a preform that comprises a body extending along a main axis (A):

The mass of the preform,

The wall thickness of the body (6) of the preform,

The height of at least one part of the preform that is measured along the main axis (A),

The inside diameter of the body (6) of the preform.

Advantageously, the container parameters comprise at least the following parameters:

The volume of the container,

The maximum diameter of the container,

The type of product that the container is designed to accommodate,

The bi-orientation level of the container,

At least one other dimension of the container,

The acceptable tolerances in terms of the dimensions of the container.

Advantageously, at least some of the pre-recorded formulas also use a machine parameter relative to the forming machine for the calculation of the adjustment parameter of the forming machine, with the machine parameter being selected from among at least the following parameters:

Production rate of the series of containers based on the series of preforms,

Number of forming stations of the forming machine. Advantageously, the adjustment parameter of the forming machine is selected from among at least one of the following parameters for a forming machine comprising a number of forming stations each comprising a mold that is designed to accommodate a preform and defining a molding cavity having the shape of the container that is to be produced, an injection device for injecting a pressurized fluid into the preform that is accommodated in the mold and a movable stretching rod in relation to the mold for stretching the preform along its main axis (A):

The pre-blow-molding pressure at which a forming fluid is introduced into a preform that is placed in a mold during a pre-blow-molding phase,

The blow-molding pressure at which a forming fluid is introduced into a preform that is placed in a mold during a blow-molding phase,

The moment when the introduction of the forming fluid into a preform begins,

The injection period of the forming fluid,

The injection flow rate of the forming fluid,

The movement of the stretching rod,

The distance between the end of the stretching rod and the bottom of the molding cavity,

The beginning of the pre-blow-molding phase in relation to the beginning of the stretching phase, during which the stretching rod stretches the preform along its main axis (A).

Advantageously, the adjustment method also comprises a step for producing at least one container in the facility that is adjusted according to the preform, container and adjustment parameters.

Advantageously, the container that is produced in the facility is used to adjust at least one other parameter of the facility apart from the forming machine.

The invention also relates to a method for adjusting a facility for producing a series of containers from a given container model based on a series of preforms made of plastic from a given preform model, with said facility comprising a station for heating said series of preforms, in which said series of preforms is heated at a reference temperature, and a machine for forming said series of preforms heated at said reference temperature, in which the preforms of said series of preforms are successively formed into containers, with the adjustment method comprising the following steps:

Determining at least one parameter for adjusting the heating, making it possible for the heating station to heat the series of preforms in conformance with said given preform model at said reference temperature,

Determining at least one container parameter relative to the container model that is to be produced based on said given preform model,

Determining at least one parameter for adjusting the forming making it possible for the forming machine to produce a series of containers in conformance with said model of containers based on said series of preforms heated to said reference temperature by means of an above-cited initial adjustment method,

Adjusting said production facility according to said preform, container, heating adjustment and forming adjustment parameters.

Advantageously, the step for determining the adjustment parameter of the heating station comprises at least one iteration of the following steps:

Determining the amount of theoretical energy that is to be provided to a preform in conformance with the preform model to heat said preform at the reference temperature,

Determining at least one machine parameter, representative of the heating capacity of the heating station,

Heating at least one preform in conformance with the preform model in said heating station that is parameterized to provide said amount of theoretical energy to said preform based on the machine parameter,

Measuring at least one parameter that is linked to the temperature of the heated preform in said heating station in such a way as to determine the deviation between the actual temperature of the preform at the end of said heating step and the reference temperature,

Adjusting the amount of energy provided by the heating station based on said deviation so that a preform that is heated by said adjusted amount of energy is heated at said reference temperature at the outlet of the heating station, with the adjustment parameter of the heating comprising said adjusted amount of energy.

The invention also relates to a computer program comprising software instructions, which, when they are executed by a computer of the production facility, make it possible to calculate the adjusted amount of energy that is to be provided to a preform based on the deviation between the actual temperature of the preform at the end of the heating step and the reference temperature for the implementation of an above-cited parameterization method.

The invention also relates to a computer program comprising software instructions, which, when they are executed by a computer of the production facility, make it possible to calculate at least one adjustment parameter of the forming machine from pre-recorded formulas, for the implementation of an above-cited initial adjustment method.

Other aspects and advantages of the invention will emerge from reading the following description, provided by way of example and referenced in the accompanying drawings, in which:

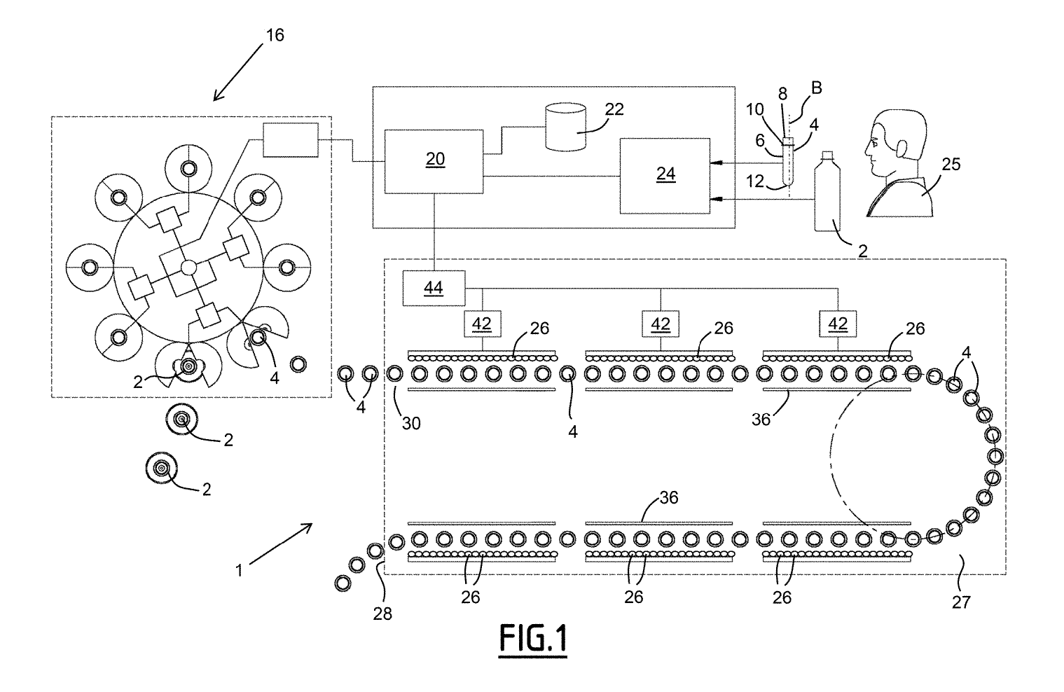

FIG. 1 is a top diagrammatic depiction of a container production facility, comprising a heating station and a forming machine, and

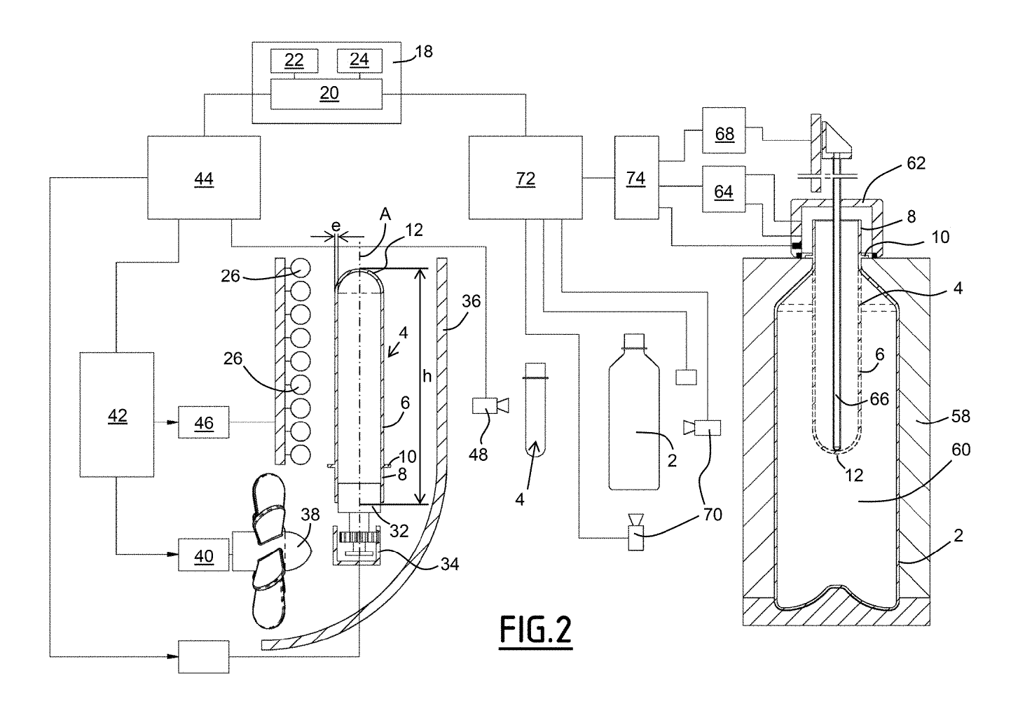

FIG. 2 is a cutaway diagrammatic depiction of the production facility of FIG. 1.

Referring to FIGS. 1 and 2, a facility 1 for producing a series of containers 2 based on a series of plastic preforms 4 is described.

According to the embodiment depicted in the figures, each preform 4 comprises a body 6, a neck 8, and a ring 10. The body 6 has, for example, the shape of a test tube with a closed bottom 12 and defines an inner volume extending along a main axis A. The neck 8 extends into the continuation of the body 6 opposite the bottom 12 and forms an upper opening through which a fluid can be introduced into the inner volume of the preform, as will be described subsequently. The neck 8 of the preform has, for example, the definitive shape that it will have in the container 2 that is formed based on the preform 4 and comprises, for example, a threading on its outer wall to make possible the attachment of a cap to the container. The ring 10 extends between the body 6 and the neck 8 radially toward the outside and forms, for example, a transport ring by which the preform can be grasped and transported, as will be described subsequently. The height h of the preform 4 is defined as being the dimension of the preform along its main axis A and the thickness e of the wall of preform 4 as being the thickness of the wall that is measured in the body 6 of the preform, with this wall separating the inner volume of the outside of the preform, as is more particularly visible in FIG. 2. The given preform shape above is only by way of example and other shapes could be considered, as long as the former are appropriate for forming a container by introducing a fluid into the preform. Thus, by way of example, the preform could have a smooth neck, be lacking a ring, and/or have other shape variants according to various preform models that can be used in the production facility 1.

The plastic material of the preform is, for example, polyethylene terephthalate (PET). The nature of the material can vary from one preform model to the next, for example because of the presence of additives, such as carbon black, which improves the absorption of radiation causing the heating, or a dye, such as titanium dioxide, which bleaches the preform and therefore reflects a portion of the radiation, or the colored pigments. As a variant, the plastic material could be different from PET, as long as this material is able to be made malleable and deformable to make it possible to produce a container by introducing a fluid into the preform.

Thus, a particular preform model can be defined by a number of parameters, so-called preform parameters. These preform parameters comprise in particular:

Characteristic(s) of the plastic material of the preform 4, such as the presence or absence of additive(s);

Mass of the preform;

Dimensions of the preform: height h of the preform 4 or at least the height of its body 6 or the height of the part of the preform that is to be heated to be formed in the production facility, the inside diameter of the body 6

Wall thickness of the body 6 of the preform.

This list of preform parameters is not exhaustive, and other parameters can be taken into account for the adjustment of the facility, as will be described subsequently.

The production facility 1 comprises at least one heating station 14 and a forming machine 16 and a control unit 18 of the production facility 1, which comprises in particular a computer 20 (or processor), a memory 22 and a console (or graphic interface 24) for interaction with an operator 25.

The heating station 14 is, for example, a furnace that makes it possible to heat a series of preforms 4 at a reference temperature, after parameterization of the heating station 14, as will be described subsequently. The reference temperature is selected so that the body 6 of each preform 4 at the outlet of the heating station 14 is in a malleable state that makes it possible to deform the body 6 of the heated preform so as to form the container 2 in the forming machine 16. The reference temperature is encompassed between the glass transition temperature and the crystallization temperature of the plastic material of the preform 4. In the case of PET, the reference temperature is, for example, close to 110°. The value of the reference temperature can vary based on the product with which the container will be filled or based on the technique for filling the container. Thus, the reference temperature is different for a hot filling or for a carbonated product, for example. It will be noted that the reference temperature corresponds to the temperature at a reference location of the preform, i.e., in a localized zone. Actually, the preform is not necessarily heated at a uniform temperature but has a temperature profile that makes the temperature of the preform vary from one zone to the next around the reference temperature.

According to the embodiment shown in FIG. 1, the heating station 14 is a moving furnace in which the preforms 4 are transported so as to be exposed to a number of heating elements 26. For this purpose, the heating station 14 comprises a transport device, or conveyor, of preforms 4 through the heating station 14 along a path extending into a chamber 27 between an inlet 28 and an outlet 30 of the heating station 14. The transport device, or conveyor, comprises, for example, a series of supports 32, each being able to support a preform 4, mounted on a belt 34, or chain, moving along the path in the heating station 14. Each support 32 is, for example, able to accommodate a preform 4 by fitting the neck 8 onto the support 32, as shown in FIG. 2. Each support 32 is, for example, movable in rotation in relation to the belt 34 around an axis of rotation that is merged with the main axis A of a preform 4 when the former is supported by the support 32. The heating elements 26 are distributed as a matrix along the path and in a transverse direction in relation to the path, with the transverse direction being essentially parallel to the main axis A of the preforms 4 when they are supported by the supports 32. In other words, the heating station 14 comprises a number of heating elements 26 that are distributed along the path and according to the height h of the preforms 4 in such a way that the entire height of the body 6 of each preform 4 is exposed to the heating elements 26 on the path of the preform 4 in the heating station. By making the preforms 4 rotate around their main axis A, the supports 32 make it possible to expose uniformly the entire body 6 of the preforms to the heating elements 26. The heating elements 26 can be distributed on both sides of the path or on only one side of this path, in which case a reflecting wall 36 can be arranged on the other side of the path to reflect the heat toward the preforms 4.

Each heating element 26 can heat at a heating power, with the addition of heating powers of the heating elements defining the maximum heating output of the heating station 14.

It should be noted that the heating elements 26 are arranged, if necessary, so as not to subject the neck 8 and the ring 10 to the heat that is emitted by the heating elements 26. Actually, as indicated above, only the body 6 of the preform is formed to produce the container 2. Consequently, the neck 8 and the ring 10 should not be deformed during forming and should not therefore be heated. To prevent the heating of the neck 8 and the ring 10, the heating station 14 can comprise a ventilation system positioned facing the necks 8 and rings 10 to evacuate the heat that can be absorbed by the necks 8 and the rings 10. The ventilation device comprises, for example, at least one fan 38 that is controlled by a motor 40.

Each heating element 26 is formed by, for example, an incandescent lamp emitting infrared radiation. It is understood, however, that the radiation could be only infrared until it is able to bring about the heating of the preforms 4. The heating elements 26 are controlled by controllers 42 that are connected to a control unit 44 of the heating station, with the control unit 44 being tied to the control unit 18 of the production facility. The controllers 42 make it possible to turn on (or supply) or turn off each of the heating elements 26 individually in such a way that it is possible to control each of the heating elements 26 and thus to decide which will be used along the path to heat the preforms traveling past in the heating station 14. The distribution of the heating elements 26 that are turned on or turned off along the path and in the transverse direction is generally referred to by the term “mapping” (cartography) of the heating elements 26.

The controllers 42 can, according to an embodiment, control the power variable-speed drive units 46, making it possible to vary the heating power of each heating element 26. However, it is preferable that the heating elements 26 be supplied with a power that is close to their maximum output when they are turned on. Thus, a variation in heating power in the heating station 14 occurs by turning on or turning off heating elements 26 rather than by varying the heating power of different heating elements 26, although such a variation can be used for a finer adjustment, as will be described subsequently.

The control unit 44 of the heating station 14 also makes it possible to control the ventilation system and the travel of the preforms in the heating station by suitable control modules, as shown in FIG. 2.

It is understood that the heating station 14 described above is only one embodiment and that the heating station 14 could be different. Thus, the heating station 14 could be a microwave heating station and/or a heating station in which the preforms are each exposed to one or more heating elements moving with the preforms along the path rather than making the preforms travel in front of successive heating elements.

At the outlet of the heating station 14, a device 48 for measuring at least one parameter linked to the temperature of a preform is provided. A parameter linked to the temperature of a preform is defined as a parameter that is representative of the temperature of the preform. The temperature of the preform is defined as the temperature of the preform at the reference location of the preform. Actually, as indicated above, the temperature of the preform is not necessarily uniform. Thus, the measuring device 48 makes it possible to know the temperature of the preforms at the outlet of the heating station 14. The parameter that is linked to the temperature of the preform is, for example, the temperature of a zone of a heated part of the preform 4. According to an embodiment, the parameter that is linked to the temperature of the preform is the temperature of a point of the body 6 of the preform 4. In this case, the measuring device 48 is therefore arranged to measure the temperature of a point of the body 6 of the preform. The measuring device 48 is formed by, for example, a heat sensor, a thermal camera, or the like. The parameter that is linked to the temperature of the preform could be different from the temperature at one zone of the preform. By way of example, it would be possible, for example, to measure the temperature of the entire body 6 of the preform 4 or to carry out a spectral analysis or the like of the preform. However, the measurement of the temperature at one point of the body is a simple and reliable means for determining the temperature of the preform 4 at the outlet of the heating station 14.

Before heating a series of preforms 4 for the purpose of producing a series of containers, it is suitable to parameterize the heating station 14 so that it delivers preforms at the desired temperature, i.e., at the reference temperature, as will now be described.

Based on the preform model of the series of preforms 4 to be formed into containers, an amount of theoretical energy that is to be provided to this preform model to raise the temperature of the preform from an initial temperature to the reference temperature is determined. To do this, at least one of the preform parameters, as defined above, is taken into account, for example the mass of the preform, to determine the amount of theoretical energy that is necessary to raise the temperature of the preform to the reference temperature. The determination of the amount of theoretical energy also takes into account the temperature of the preform 4 before passing into the heating station 14. To do this, the production facility comprises, for example, means for measuring the temperature in the environment of the facility, i.e., measuring the ambient temperature. As a variant, the facility can comprise means for measuring directly the temperature of the preforms at the inlet 28 of the heating station 14.

The preform parameter(s) can be acquired by the operator 25 by means of the interface 24 and/or they can be measured by suitable means at the inlet 28 of the heating station 16.

Based on the information above, the computer 20 can determine the parameterization, or adjustment, of the heating station 14 so that the former provides the amount of theoretical energy to at least one preform 4 that circulates in the heating station 14.

This parameterization takes into account at least one machine parameter of the heating capacity of the heating station 14. This machine parameter is, for example, the operating pace at which the heating station 14 is to heat the series of preforms 4, i.e., the flow rate of preforms circulating in the heating station 14 up to the outlet 30. Actually, this operating pace determines the speed at which a preform 4 circulates in the heating station 14 and therefore the maximum exposure time of the preform 4 to the heating elements 26 along the path of the preform 4 in the heating station 14.

The parameterization of the heating station 14 also takes into account a theoretical yield coefficient of the heating station 14. The theoretical yield coefficient determines the amount of energy actually received by a preform in relation to the amount of energy emitted by the heating elements 26 of the heating station 14. Actually, as indicated above, there are energy losses in the heating station 14, for example due in part to the ventilation system, and the preform does not necessarily absorb all of the energy that it receives. Based on the specifications of the heating station 14 and the preform model, the theoretical yield coefficient of the heating station 14 that corresponds to the ratio between the amount of energy in theory actually received by a preform and the amount of energy in theory emitted by the heating station 14 is thus known.

Based on the length of exposure of a preform to the heating elements 26 and the theoretical yield coefficient, the control unit 18 determines the fraction of the maximum heating output that is necessary to provide the amount of theoretical energy to a preform to heat it at the reference temperature. The control unit thus determines the mapping of heating elements 26 corresponding to the fraction of the maximum heating output so that a preform 4 circulating in the heating station 14 receives the amount of theoretical energy between the inlet 28 and the outlet 30 of the heating station 14. As indicated above, the mapping indicates which heating elements 26 are turned on and at what heating power, and which are turned off along the path and in the transverse direction. The mapping is such that the fraction of the maximum heating output is distributed over the different heating elements 26 to apply a desired heating profile on the preform, by supplying, preferably as indicated above, the heating elements 26 that are turned on close to their maximum output. The height of the preform is taken into account to determine the mapping in the transverse direction so as to obtain the desired temperature profile along the preform. The distribution of the heating elements 26 that are turned on along the path is also arranged to obtain a homogeneous heating in the thickness of the wall of the body of the preform.

The control unit 18 controls the control unit 44 of the heating station for applying the mapping that is thus determined by means of the controllers 42.

Once this initial parameterization is carried out, at least one test preform in conformance with the preform model is introduced into the heating station 14, which is parameterized to provide the amount of theoretical energy to the test preform. Preferably, a number of test preforms are introduced into the heating station 14 so as to obtain more reliable data.

At the outlet 30 of the heating station 14, the parameter that is linked to the temperature of the test preform or of each test preform is measured by means of the measuring device 48 so as to determine the actual temperature of the test preform at the outlet of the heating station 14. Actually, to the extent that the initial parameterization of the heating station is carried out in part based on theoretical data (such as the specifications of the heating station 14, for example), there is a good chance that the temperature of the test preform at the outlet of the heating station 14 is not equal to the reference temperature at which it is desired to heat the preform. Thus, at the outlet of the heating station 14, the deviation between the actual temperature of the test preform at the end of said heating step and the reference temperature is determined.

Based on this deviation, the computer can calculate the amount of actual energy that is to be provided to a preform in conformance with the preform model to heat it to the reference temperature. This amount of energy is called adjusted amount of energy. Such a calculation is made based on a computer program comprising software instructions, which, when they are executed by the computer, make it possible to calculate the amount of actual energy that is to be provided to a preform based on the deviation between the temperature at the outlet of the heating station and the reference temperature. Such a computer program can be introduced into the computer from a physical support, such as a USB stick or the like, or by downloading from a remote server.

Based on the calculation of the adjusted amount of energy, the actual yield coefficient of the heating station 14 is determined, and the fraction of the maximum output that makes it possible to heat the preform at the reference temperature is thus adjusted. This adjusted fraction is distributed over the heating elements 26, i.e., the mapping is modified to apply the adjusted amount of energy to the preforms 4 circulating in the heating station 14. If the temperature deviation calls for increasing the amount of energy to reach the adjusted amount of energy, the modified mapping is such that a larger number of heating elements 26 are turned on to increase the heating power. If the temperature deviation in contrast calls for reducing the amount of energy to reach the adjusted amount of energy, the modified mapping is such that a smaller number of heating elements 26 are turned on to reduce the heating power. If turning on or turning off heating elements 26 does not make it possible to result in the adjusted amount of energy, the power of at least a part of the heating elements can also be modified by means of the power variable-speed drive units 46 so as to reach the exact value desired.

The adjusted amount of energy is thus used as a parameterization of the heating station 14 by the control unit 18. Owing to this parameterization of the heating station 14 that is obtained by calculation after a test step, it is ensured that the series of preforms, in conformance with the preform model for which the parameterization was carried out, have been heated at the reference temperature during the production of containers. By adjusted amount of energy that is used as a parameterization, it is understood that the mapping that is obtained for applying this amount of energy is recorded in the memory 22 and is applied to the heating station 14 during production. Other parameters can be recorded, such as the adjusted yield coefficient, the adjusted fraction of the total heating power, etc. It will be noted that the determination of the mapping is also done by a computer program.

According to an embodiment, the method for parameterization of the heating station 14 can also comprise a new test step during which at least one new test preform in conformance with the preform model is heated in the parameterized heating station 14 to apply the adjusted amount of energy. At the end of this heating step, the parameter that is linked to the temperature of the test preform is measured at the outlet of the heating station 14. The deviation between the measured temperature and the reference temperature is then determined. If the temperature deviation is zero, this means that the parameterization of the station was carried out correctly. If a non-zero deviation is noted, an adjusted amount of energy is recalculated, and the steps described above are begun again to parameterize the heating station 14. These steps can be repeated until the temperature of the preform at the outlet of the heating station 14 is essentially equal to the reference temperature.

The parameterization method described above can be entirely automated and implemented by the control unit 18 by means of computer programs. In addition, it can be implemented independently of the adjustment of the rest of the facility, in particular that of the forming machine 16, which will be described subsequently. Thus, the parameterization of the heating station 14 and the adjustment of the forming machine 16 can be carried out in parallel, which makes significant time savings possible. In addition, if a defect is noted in the container production, the heating station 14 and/or the forming machine 16 can again be adjusted without undoing the adjustment of the rest of the facility.

The forming machine 16 makes it possible to form the series of preforms 4 that are heated at the reference temperature into a series of containers 2.

For this purpose, the production facility comprises means (not shown) for transfer of the series of preforms 4 at the outlet of the heating station 14 to the forming machine 16. These transfer means are formed, for example, in a known way, by a transfer wheel that can move in rotation around an axis of rotation and is arranged to grasp the preforms 4, for example by the ring 10 of the preforms, at the outlet 30 of the heating station 14 and to transfer them to an inlet 50 of the forming machine 16. The axis of rotation of the transfer wheel is, for example, parallel to the main axis A of the preforms when they are transported via the transfer wheel.

The forming machine 16 is also formed by, for example, a forming wheel 52 that moves in rotation a number of forming stations 54 from the inlet 50 to an outlet 56, in which a series of containers 2 formed from preforms 4 is extracted, as shown in FIG. 1. The axis of rotation of the forming wheel 52 is, for example, essentially parallel to the main axis A of the preforms 4 when they are transported via the forming wheel 52.

Each forming station 54 comprises a mold 58 that forms a molding cavity 60 that has the shape of the container 2 that is to be formed and arranged to accommodate a preform 4 in such a way that the body 6 of the preform 4 extends into the molding cavity 60, as shown in FIG. 2. Each mold 58 is formed by, for example, several movable parts between an open position, in which the mold 58 can accommodate a preform 4 and release a container 2, respectively at the inlet 50 and the outlet 56, and a closed position, in which the molding cavity 60 is hermetically sealed by the preform 4 between the inlet 50 and the outlet 56. When a preform is accommodated in the mold, the body 6 extends into the molding cavity 60, and the neck 8 extends projecting from the mold 58 beyond the molding cavity 60, as shown in FIG. 2.

Each forming station 54 also comprises an injection device 62 that is arranged to inject a fluid into the inner volume of the preform 4 that is placed in the mold 58 of the forming station 54 in such a way that the fluid deforms the preform 4 and the former acquires the shape of the molding cavity 60, i.e., the preform is formed into a container under the action of the fluid. According to an embodiment, the fluid is, for example, a pressurized gas, for example compressed air. In this case, the injection device 62 is, for example, formed by a nozzle and one or more valves 64 making it possible to control the injection of fluid into the preform. The pressure at which the fluid is injected is adjustable. By way of example and in a known way, the forming facility comprises a reservoir of compressed air at a first pressure and a reservoir of compressed air at a second pressure, with the valves 64 making it possible to inject air selectively at the first pressure or at the second pressure.

According to an embodiment, shown in FIG. 2, each forming station 54 also comprises a stretching rod 66 that can move in relation to the mold 58 in a direction that is merged with the main axis A of the preform 4 when it is placed in the mold 58. The stretching rod 66 is arranged to exert a support on the bottom 12 of the preform 4 so as to extend the former in the axial direction. More particularly, the stretching rod 66 extends, for example, the preform 4 until the bottom 12 comes into contact with the bottom of the molding cavity 60. The movement of the stretching rod 66 is controlled by an actuator 68.

The forming machine 16 can also comprise means for controlling the quality of the containers 2 at the outlet 56 of the forming machine 16. Such means comprise, for example, cameras 70 that point toward the body and/or the bottom of the containers 2 or the like, as shown in FIG. 2.

The forming machine 16 is guided in an automatic manner by a dedicated control unit 72 that is tied to the control unit 18 of the production facility. This control unit 72 guides controllers 74 that are associated with each of the forming stations 54 to control the valves 64 and the actuator 68 of the stretching rod 66.

As indicated above, each forming station 54 accommodates a preform 4 at the inlet 52 of the forming machine 16. The mold 58 is closed, and the injection device 62 is positioned around the neck 8 of the preform 4. The pressurized fluid is then injected into the preform 4 to form the former into a container. According to an embodiment, two injection phases are provided:

A first phase, a so-called pre-blow-molding phase, during which the fluid is injected at a first pressure, a so-called pre-blow-molding pressure, for example on the order of 4 to 16 bar, so as to apply the wall of the preform 4 against the wall of the molding cavity 60,

A second phase, a so-called blow-molding phase, during which the fluid is injected at a second pressure, a so-called blow-molding pressure, for example on the order of 20 to 30 bar, in such a way as to flatten the wall of the container against the wall of the molding cavity 60 so that all of the details (ribs, patterns, etc.) of the wall of the molding cavity 60 are firmly impressed onto the wall of the container 2.

If necessary, the forming of the container 2 also comprises a stretching phase by means of the stretching rod 66, with this phase beginning before or after the beginning of the first injection phase and continuing during this first phase until the bottom 12 of the preform 2 enters into contact with the bottom of the molding cavity 60.

These phases occur when the forming station 54 moves from the inlet 52 to the outlet 56. At the outlet 56, the mold 58 is open, and a formed container is extracted from the mold.

The container 2 that is obtained is in conformance with a container model that can be defined by a number of parameters, so-called container parameters. These container parameters comprise in particular:

The volume of the container,

The maximum diameter of the container,

The type of product that the container is designed to accommodate,

The bi-orientation level of the container, corresponding to the product of the axial elongation ratio owing to stretching and the radial elongation ratio owing to the injection of the pressurized fluid,

At least one other dimension of the container, such as the height of the container,

The acceptable tolerances in terms of the dimensions of the container.

The container that is obtained at the end of the forming can then be labeled, filled and capped, for example, by means of stations that are provided for this purpose in the production facility.

Before forming a series of containers 2 from a series of preforms, it is advisable to adjust the forming machine 16 so that it forms containers in conformance with a desired container model starting from preforms 4 of a given preform model, as will now be described.

The adjustment of the forming machine 16 comprises an initial adjustment of the forming machine, so that after the initial adjustment, the forming machine forms containers coming close to the container model, and then a refined adjustment making it possible to adjust the machine in such a way that it forms containers in conformance with the container model.

The initial adjustment of the forming machine 16 consists in determining at least one adjustment parameter of the blow molding making it possible for the blow-molding machine to form a container in conformance with the container model based on a preform 4 in conformance with a given preform model and heated at the reference temperature.

This determination is obtained by calculation by means of the computer 20 of the control unit 18. The calculation is carried out based on formulas that are pre-recorded in the memory 22 of the control unit and using at least one preform parameter and at least one container parameter. More particularly, the formulas make it possible to calculate the value of at least one adjustment parameter of the blow-molding machine 16 based on at least one preform parameter and at least one container parameter. Certain formulas also integrate “machine” parameters relative to the operation of the machine, such as the operating pace at which the forming machine 16 produces containers, the number of forming stations of the forming machine, etc. The calculations are made by a computer program comprising software instructions, which, when they are executed by the computer, make possible the calculations of the adjustment parameter(s) based on pre-recorded formulas. Such a computer program can be introduced into the computer from a physical support, such as a USB stick or the like, or by downloading from a remote server.

The adjustment parameters of the blow-molding machine 16 comprise, for example:

The pre-blow-molding pressure,

The blow-molding pressure,

The moment when the introduction of the forming fluid into a preform begins,

The injection period of the forming fluid,

The injection flow rate of the forming fluid,

The travel of the stretching rod 66, for example the course of the travel, the travel speed and/or the travel profile over time,

The distance between the end of the stretching rod 66 and the bottom of the molding cavity 60,

The beginning of the pre-blow-molding phase in relation to the beginning of the stretching phase.

The formulas are obtained by regression of a database containing information correlating a number of adjustment parameters of the forming machine 16 to a number of preform models and a number of container models. Such information is known under the name of “recipes” that each comprise values of adjustment parameters of the forming machine for producing a particular container model based on a particular preform model in a given blow-molding machine. Such recipes are described in, for example, the document WO-2016/012704. By regression based on all of the recipes stored in a database, formulas are obtained making it possible to calculate the value of adjustment parameters. Thus, the adjustment parameters can be calculated for container models and/or preform models, even if these models are not present in the database, owing to information contained in the database for other container and preform models.

By way of example, the pre-blow-molding pressure, the blow-molding pressure and/or the injection period of the expansion fluid can be calculated based on the dimensions of the preform, the dimensions of the container, the volume of the container, and the operating pace of the forming machine 16.

Specifically, an operator 25 gives information about a container model that is to be produced and a preform model based on which the containers are to be produced by means of the interface 24. The computer 20 then carries out the calculations making it possible to determine the adjustment parameters of the forming machine 16 based on formulas stored in the memory 22 based on preform and container parameters and machine parameters. The control unit 18 transmits these adjustment parameters so that the control unit 74 of the forming machine 16 applies them.

With the initial adjustment thus carried out, at least one test container that is based on a preform that is heated at the reference temperature is produced. The test container that is obtained is close to the desired container model.

The test container(s) can be used to adjust other parameters of the production facility, for example to adjust the stations for transfer of containers from one unit to the next unit or the unit for labeling or filling or capping a container. Actually, with the test container being close to the desired model, it is enough to adjust elements not requiring that the container be perfectly in conformance with the desired container model.

In parallel with these complementary adjustments, the adjustment of the forming machine 16 is refined so that the forming machine produces containers in conformance with the desired container model. This adjustment is carried out by measuring at least one characteristic of the test container that is obtained at the end of the initial adjustment, by determining a deviation between this characteristic and the expected value for the model and correcting at least one adjustment parameter of the forming machine 16 consequently so as to make this deviation zero.

Thus, complementary adjustments can be carried out without expecting that the forming machine 16 is completely adjusted, which makes significant time savings possible.

The forming machine above has been described only by way of example, and other types of forming machines could be adjusted by means of the method described above. For example, the forming machine may not comprise a forming wheel or stretching rods. The injected fluid may be other than air, etc.

1. Method for parameterization of a station (14) for heating a series of preforms (4) made of plastic from a given preform model for a facility (1) for producing a series of containers (2) of a given container model based on said series of preforms (4) heated at a reference temperature in said heating station (14), with the adjustment method comprising the following steps:
Determining at least one preform parameter relative to the given preform model,
Determining at least one machine parameter, representative of the heating capacity of the heating station (14),
Determining at least one heating adjustment parameter, making it possible for the heating station (14) to heat the series of preforms (4) in conformance with said given preform model at said reference temperature based on the machine parameter,
Adjusting said heating station (14) according to said preform and heat adjustment parameters,
wherein the step for determining the adjustment parameter of the heating station comprises at least one iteration of the following steps:
Determining the amount of theoretical energy that is to be provided to a preform in conformance with the preform model for heating said preform at the reference temperature,
Heating at least one preform (4) in conformance with the preform model in said parameterized heating station (14) to provide said amount of theoretical energy to said preform,
Measuring at least one parameter that is linked to the temperature of the preform (4) that is heated in said heating station (14) in such a way as to determine the deviation between the actual temperature of the preform at the end of said heating step and the reference temperature,
Adjusting the amount of energy provided by the heating station based on said deviation so that a preform that is heated by said adjusted amount of energy is heated at said reference temperature at the outlet (30) of the heating station (14), with the heating adjustment parameter comprising said adjusted amount of energy.

2. Parameterization method according to claim 1, in which the parameterization of the heating station (14) for applying the amount of theoretical energy that is to be provided to the preform takes into account an initial yield coefficient of the heating station (14) between the energy that is emitted by the heating station (14) and the energy that is actually received by the preform (4), with an actual yield coefficient being calculated based on the deviation between the actual temperature of the preform (4) at the end of the heating step and the reference temperature, with said actual yield coefficient being taken into account to adjust the heating station (14) in such a way as to provide the adjusted amount of energy to the preform (4).

3. Parameterization method according to claim 1, in which the heating station (14) comprises at least one heating element (26) that can emit a heating power toward the preform (4), with the adjustment of the amount of energy provided by the heating station (14) comprising a modification of said heating power based on the length of exposure of said preform (4) to said heating power emitted by the heating element (26).

4. Parameterization method according to claim 3, in which the heating station (14) comprises a chamber (27), a conveyor that conveys the series of preforms (4) along a path that runs through the chamber, the preforms (4) having a body (6) extending in a transverse direction in relation to the path, and a series of heating elements (26) distributed in a matrix along the path and in the transverse direction, with said heating elements (26) being able to emit a maximum heating output corresponding to the addition of the heating powers of each heating element (26), the adjustment of the heating station (14) to apply the amount of theoretical energy comprising the calculation of a fraction of said maximum heating output corresponding to said amount of theoretical energy based on the length of exposure of a preform (4) to the heating elements (26) along the path and the distribution of said fraction over at least a part of said heating elements (26) and the adjustment of the heating station (14) to apply the adjusted amount of energy comprising the calculation of an adjusted fraction of said maximum heating output corresponding to said adjusted amount of energy based on the length of exposure of a preform (4) to the heating elements (26) along the path and the distribution of said adjusted fraction over at least a part of said heating elements (26), with said distribution of the adjusted fraction forming an adjustment parameter of the heating station.

5. Parameterization method according to claim 4, in which the distribution of a fraction of the maximum heating output comprises the selection of heating elements (26) to turn on along the path and the supplying of said heating elements (26) at a heating power that is close to their maximum output.

6. Parameterization method according to claim 5, in which the increase in the amount of energy during the adjustment step of the heating station (14) for applying the adjusted amount of energy comprises the selection and the supplying of additional heating elements (26) and in which the reduction of the amount of energy during the adjustment step of the heating station for applying the adjusted amount of energy comprises the selection and the turning off of heating elements (26) among the selected heating elements (26) and/or the modification of the heating power of at least a part of said heating elements (26).

7. Parameterization method according to claim 1, in which the input parameter relative to the preform model (4) that is introduced into the facility comprises the mass and the height of at least a part of the preform (4) that is measured along the axis (A) of said preform, with said preform part being the part of the preform (4) that is designed to be heated in the heating station (14).

8. Parameterization method according to claim 1, in which the parameter that is linked to the temperature of the preform that is heated in the heating station (14) comprises the temperature that is measured in a given zone of the preform (4).

9. Method for initial adjustment of a facility (1) for producing a series of containers (2) from a given container model based on a series of preforms (4) made of plastic from a given preform model, with said facility comprising a station (14) for heating said series of preforms (4), in which said series of preforms (4) is heated at a reference temperature, and a machine (16) for forming said series of preforms (4) that are heated at said reference temperature, in which the preforms (4) of said series of preforms are successively formed into containers (2), with the adjustment method comprising the following steps:
Determining at least one adjustment parameter of the heating making it possible for the heating station (14) to heat the series of preforms (4) in conformance with said given preform model at said reference temperature by means of the method for parameterization of a heating station (14) according to claim 1,
Determining at least one container parameter relative to the container model that is to be produced based on said given preform model,
Determining at least one adjustment parameter of the forming making it possible for the forming machine (16) to produce a series of containers in conformance with said container model based on said series of preforms that are heated at said reference temperature,
Adjusting said production facility (1) according to said preform, container, heating adjustment, and forming adjustment parameters.

10. Adjustment method according to claim 9, in which the step for determination of at least one adjustment parameter of the forming machine (16) comprises the calculation of said parameter based on pre-recorded formulas and said input parameters, with said formulas linking at least the input parameter relative to the preform model to the input parameter relative to the container model that is to be produced based on the adjustment parameter of the forming.

11. Computer program comprising software instructions, which, when they are executed by a computer (20) of the production facility, make it possible to calculate the adjusted amount of energy that is to be provided to a preform based on the deviation between the actual temperature of the preform at the end of the heating step and the reference temperature for implementing a parameterization method according to claim 1.

12. Parameterization method according to claim 2, in which the heating station (14) comprises at least one heating element (26) that can emit a heating power toward the preform (4), with the adjustment of the amount of energy provided by the heating station (14) comprising a modification of said heating power based on the length of exposure of said preform (4) to said heating power emitted by the heating element (26).

13. Parameterization method according to claim 2, in which the input parameter relative to the preform model (4) that is introduced into the facility comprises the mass and the height of at least a part of the preform (4) that is measured along the axis (A) of said preform, with said preform part being the part of the preform (4) that is designed to be heated in the heating station (14).

14. Parameterization method according to claim 3, in which the input parameter relative to the preform model (4) that is introduced into the facility comprises the mass and the height of at least a part of the preform (4) that is measured along the axis (A) of said preform, with said preform part being the part of the preform (4) that is designed to be heated in the heating station (14).

15. Parameterization method according to claim 4, in which the input parameter relative to the preform model (4) that is introduced into the facility comprises the mass and the height of at least a part of the preform (4) that is measured along the axis (A) of said preform, with said preform part being the part of the preform (4) that is designed to be heated in the heating station (14).

16. Parameterization method according to claim 5, in which the input parameter relative to the preform model (4) that is introduced into the facility comprises the mass and the height of at least a part of the preform (4) that is measured along the axis (A) of said preform, with said preform part being the part of the preform (4) that is designed to be heated in the heating station (14).

17. Parameterization method according to claim 6, in which the input parameter relative to the preform model (4) that is introduced into the facility comprises the mass and the height of at least a part of the preform (4) that is measured along the axis (A) of said preform, with said preform part being the part of the preform (4) that is designed to be heated in the heating station (14).

18. Parameterization method according to claim 2, in which the parameter that is linked to the temperature of the preform that is heated in the heating station (14) comprises the temperature that is measured in a given zone of the preform (4).

19. Parameterization method according to claim 3, in which the parameter that is linked to the temperature of the preform that is heated in the heating station (14) comprises the temperature that is measured in a given zone of the preform (4).

20. Parameterization method according to claim 4, in which the parameter that is linked to the temperature of the preform that is heated in the heating station (14) comprises the temperature that is measured in a given zone of the preform (4).
